(19) United States
(12) Patent Application Publication
(10) Pub. No.: US 2002/0059300 A1
(43) Pub. Date: May 16, 2002

(54) System, method and recording medium for centralized management of medical images

(75) Inventors: Takefumi Nagata, Kaisei-machi (JP); Kazuo Shimura, Kaisei-machi (JP); Takeshi Ohkubo, Kaisei-machi (JP)

Correspondence Address: SUGHRUE, MION, ZINN, MACPEAK & SEAS, PLLC, 2100 Pennsylvania Avenue, N.W., Washington, DC, 20037-3202, US

(73) Assignee: FUJI PHOTO FILM CO., LTD.

(21) Appl. No.: 09/901,610

(22) Filed: Jul. 11, 2001

(30) Foreign Application Priority Data
Jul. 11, 2000 (JP) 209176/2000

(51) Int. Cl. G06F 7/00

(52) U.S. Cl. 707/104.1

(57) ABSTRACT

Storage space for medical image data in medical facilities can be reduced substantially at low cost, and the medical image data can be stored and managed by an easy operation. Medical image data converted from medical images photographed in medical facilities into digital signals are stored in hard discs of client terminals, in addition to accompanying information regarding the image data. Each of the client terminals is connected to an image database server installed in an Internet provider via a telephone line. The image data and the accompanying information stored in the image database server are transmitted, received, and searched for by checking a password.

### BACKGROUND OF THE INVENTION

1. Field of the Invention

The present invention relates to a system and a method for centralized management of medical image data. More specifically, the present invention relates to a system and a method for centralized management of medical image data owned by a plurality of medical facilities.

2. Description of the Related Art

Various medical images such as radiation images, CT images, and MR images have been in wide use for medical treatment and research in medical facilities such as clinics and hospitals. Such medical images need to be stored in order to understand changes in patients' conditions. Furthermore, storing such images is also mandatory for a predetermined period. Therefore, in medical facilities, the number of medical images to be stored is continuously on the rise. Medical images have been conventionally stored in the form of hard copies, and medical facilities are burdened with securing storage space and management or search of the images.

Recently, a so-called image filing apparatus in which images such as medical images are recorded (filed) as searchable image data in a recording medium such as an optical disc and a magnetic disc has been proposed. By using such an image filing apparatus to record medical images in a recording medium, space and labor for storing images can be saved and search of images becomes easier and faster.

Meanwhile, an amount of image data representing even one medical image is substantially large. Therefore, although an optical disc has an extremely large capacity, the number of optical discs storing ever-increasing image data is growing. For this reason, a library unit enabling storage of a plurality of optical discs and enabling recording and reading of image data in the optical discs has been proposed (see Japanese Unexamined Patent Publication Nos. 2(1990)-211516, 2(1990)-211581, and 2(1990)-214978). By using such a library unit, an extremely large amount of image data can be stored and managed.

However, the library unit described above stores a plurality of optical discs only physically, and a large number of optical discs are necessary to store a large amount of image data. Therefore, regardless of using or not using the library unit, medical facilities need to find room for storing the rapidly increasing amount of recording media such as optical discs.

Furthermore, since the library unit described above is extremely expensive, a large amount of equipment investment is needed. Even if the library unit is not used, expense for purchasing a large number of recording media is a burden to medical facilities.

Especially, small-scale private medical facilities such as private clinics are substantially burdened with the storage space and the cost therefor. Moreover, since installation and operation for image data management is complex, it is difficult for such private medical facilities to carry out everything by themselves.

### SUMMARY OF THE INVENTION

The present invention has been conceived based on consideration of the problems described above. An object of the present invention is therefore to provide a system and a method for centralized management of medical image data for enabling reduction in storage space of the image data at low cost and easy operation, and also to provide a recording medium storing a program to cause a computer to execute the method.

A centralized medical image management system of the present invention comprises client terminals installed in medical facilities and an image database server. The client terminals enable transmission and reception of sets of medical image data together with accompanying information regarding the sets of the medical image data via a public communications network. The image database server receives the sets of the medical image data and the accompanying information transmitted from the client terminals via the public communications network, stores the sets of the medical image data and the accompanying information that have been received, searches for a desired one of the sets of the medical image data stored therein by using the accompanying information, and transmits the desired set of the medical image data. By an input of a desired search condition using a portion of the accompanying information from one of the client terminals to the image database server, the image database server searches for the set of the medical image data corresponding to the search condition and transmits the set of the medical image data to the client terminal.

Transmission and reception of the sets of the medical image data “together with the accompanying information” refers to transmission and reception of the sets of the medical image data comprising the accompanying information, or transmission and reception of the accompanying information separately from the sets of the medical image data if the accompanying information corresponding to the respective sets of the medical image data can be specified.

The image database server may have all the functions of reception, storage, search, and transmission of the sets of the medical image data and the accompanying information. Alternatively, the image database server may comprise a plurality of servers respectively dedicated to a combination of the above functions, or a plurality of servers for the respective medical facilities.

It is preferable for the image database server to compare a password input from one of the client terminals with a password stored therein. If the passwords match up, the set of medical image data corresponding to the accompanying information input as the search condition from the client terminal is searched for by the image database server to be transmitted to the client terminal.

It is preferable for the accompanying information to include at least one of items comprising patient specification information, the date of photographing, a photographing menu, an input modality, and facility information. The patient specification information refers to patient information such as a name, gender, and the date of birth of a patient, in addition to any information enabling identification of the patient such as an ID number or a consultation ticket number. The photographing menu includes information of a photographed body portion and a photographing method. The input modality refers to the type of an image-data input apparatus such as a radiography apparatus, a CT apparatus, and an MR apparatus.

It is more preferable for the accompanying information to include a combination of the facility information and the patient specification information. The patient specification information may be encrypted in the medical facilities.

The image database server used in the centralized medical image management system of the present invention receives the sets of medical image data and the accompanying information from the client terminals via the public communications network, stores and manages the sets of medical image data and the accompanying information, searches for a desired one of the sets of medical image data stored therein by using the accompanying information, and transmits the set of medical image data.

It is preferable for the image database server to receive the password and to compare the password with the password stored therein. If the passwords agree, the set of medical image data is searched for based on the accompanying information.

Each of the client terminals used in the centralized medical image management system of the present invention comprises transmission means for transmitting the sets of medical image data together with the accompanying information regarding the sets of the image data to the image database server via the public communications network, search condition transmission means for transmitting a search condition using the accompanying information used for searching the sets of medical image data stored in the image database server for a desired one of the sets of medical image data, and image data reception means for receiving the set of medical image data corresponding to the search condition.

It is preferable for each of the client terminals to further comprise password transmission means for transmitting the password to the image database server.

A centralized medical image management method of the present invention comprises the steps of:

installing client terminals in medical facilities for enabling transmission and reception of sets of medical image data together with accompanying information regarding the sets of the medical image data via a public communications network;

transmitting the sets of the medical image data and the accompanying information via the public communications network from the client terminals to an image database server installed separately from the medical facilities;

storing the sets of the medical image data and the accompanying information in the image database server;

inputting a desired search condition using a portion of the accompanying information from one of the client terminals to the image database server; and

searching the image database server for a desired one of the sets of the medical image data corresponding to the accompanying information based on the search condition, and transmitting the set of medical image data from the image database server to the client terminal.

The centralized medical image management method of the present invention may be provided as a program stored in a computer-readable recording medium to cause a computer to execute the method.

According to the centralized medical image management system and the centralized medical image management method of the present invention, the sets of the medical image data and the like owned by the medical facilities can be stored in the image database server installed separately from the medical facilities. Therefore, each of the medical facilities does not need to store a recording medium storing the medical image data. As a result, space and cost for storage can be saved.

Furthermore, by installing the client terminals having the functions of transmitting and receiving the sets of the medical image data and the like, a large number of recording media for storing the sets of the medical image data and an apparatus for storing the recording media become unnecessary. Consequently, the cost for storage can be reduced substantially.

Moreover, since the image database server has the functions of reception, storage, search and transmission of the sets of the medical image data and the like, each of the medical facilities can manage the sets of the medical image data and the like by a simple operation and can search for a desired one of the sets of the medical image data from a substantially large amount of the medical image data.

In the case where the password is checked before the search for the desired set of the medical image data, an access to the sets of the medical image data and to the accompanying information stored in the image database server is limited, which assures security.

If data comprising the facility information and the patient specification information are added to the accompanying information, the patient specification information can be managed individually by each of the medical facilities. In other words, if a patient is identified by the combination of the patient specification information and the facility information, the patient can be identified even if the same patient specification information is used for another patient in another one of the medical facilities. As a result, a simple number such as a consultation ticket number conventionally used by the medical facilities can be used as the patient specification information.

In the case where the patient specification information is encrypted by each of the medical facilities, personal information such as the medical image data and the accompanying information can be prevented from being leaked.

### BRIEF DESCRIPTION OF THE DRAWINGS

FIG. 1 is a diagram showing a configuration of a centralized medical image management system as an embodiment of the present invention;

FIG. 2 is a diagram showing a configuration of an image database server used in the embodiment;

FIG. 3 is a flow chart of data storage processing in the centralized medical image management system;

FIG. 4 shows an example of image data comprising accompanying information used in the centralized medical image management system of the present invention; and

FIG. 5 is a flow chart showing data search processing in the centralized medical image management system of the present invention.

### DESCRIPTION OF THE PREFERRED EMBODIMENT

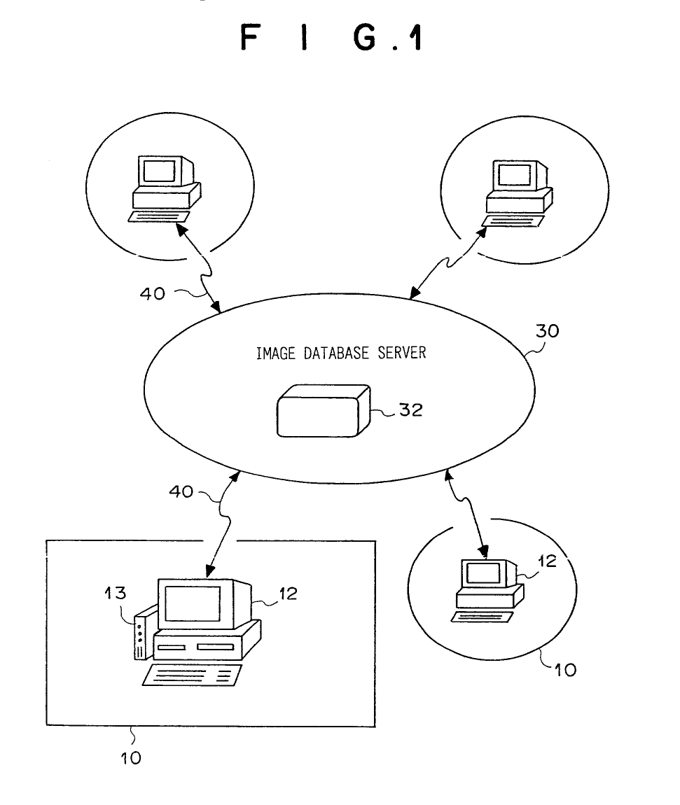

Hereinafter, an embodiment of a system and a method for centralized medical image management of the present invention will be explained with reference to the accompanying drawings. FIG. 1 is a diagram showing a configuration of the centralized medical image management system of the present invention.

A centralized medical image management system in this embodiment comprises client terminals 12 installed in a plurality of medical facilities 10, and an image database server 32 installed in an Internet provider 30.

Medical images such as radiation images photographed in the medical facilities 10 are converted into digital signals and stored as medical image data sets in hard discs of the client terminals 12 installed in the medical facilities. Accompanying information regarding the medical image data sets, such as patient specification information, facility information, and information of the date of photographing, a photographing menu, and an input modality is also recorded together with the image data sets. The patient specification information refers to information enabling identification of a patient, such as an ID number or a consultation ticket number, in addition to information on a name, gender and the date of birth of the patient.

The accompanying information maybe stored separately from the image data sets if the respective image data sets corresponding to the accompanying information can be identified.

Each of the client terminals 12 comprises a modem 13 connected to the Internet via a telephone line 40. Each of the client terminals 12 is connected to the image database server 32 in a state where transmission and reception of the image data sets and the accompanying information is possible.

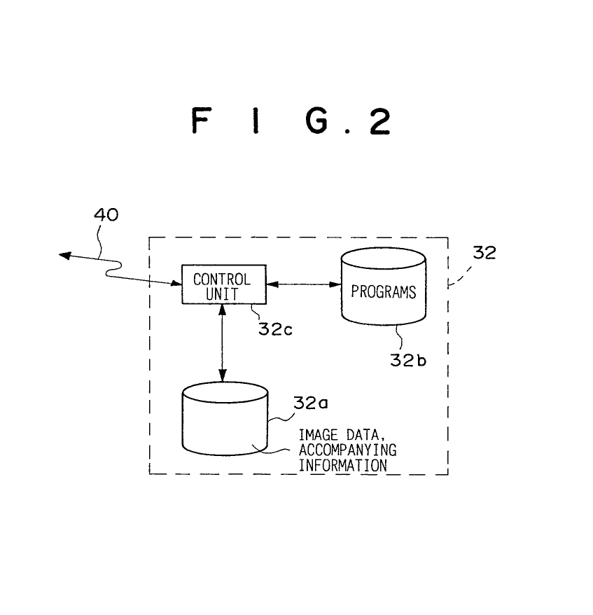

The image database server 32 is installed in the Internet provider 30. The image database server 32 comprises a data storage unit 32a for storing the image data sets and the accompanying information, a program storage unit 32b for storing programs for searching for a desired one of the image data sets stored in the server and for controlling display or the like of the client terminals, and a control unit 32c for controlling data transmission and reception (see FIG. 2). The control unit 32c controls reception of the image data sets and the accompanying information transmitted from the client terminals via the telephone line 40 and data transmission to the client terminals 12. The data storage unit 32a stores the image data sets and the accompanying information transmitted from the client terminals 12. The program storage unit 32b stores a program for displaying a data search screen on any one of the client terminals 12 used at the time of search for a desired one of the image data sets, and a program for carrying out the search based on a search instruction from the client terminal 12 requesting the search.

Each of the client terminals 12 in any one of the medical facilities 10 (hereinafter called the medical facility 10) comprises password transmission means for transmitting a password when the image data sets therefrom are stored in the image database server 32 or when a desired one of the image data sets stored in the image database server is searched for. The password transmission means transmits the password input to a password input screen displayed on any one of the client terminals 12 from an input device (such as a keyboard) of the client terminal, based on a program stored in the program storage unit 32b of the image database server 32. The password is a character string or the like set in advance for each of the medical facilities 10 in order to judge permission of storing and accessing the image data sets.

Each of the client terminals 12 also has search condition transmission means for transmitting a search condition used for searching for a desired one of the image data sets. The search condition transmission means transmits the search condition input to a search condition input screen displayed on any one of the client terminals 12 from the input device of the client terminal, based on a program stored in the program storage unit 32b of the image database server 32.

Each of the client terminals 12 further has a function of receiving the desired one of the sets of image data and the like corresponding to the specified search condition from the image database server 32 via the telephone line 40.

It is preferable for the Internet provider to have the image database server 32 individually for each of the medical facilities 10, in order to manage the image database servers 32 for the respective medical facilities 10.

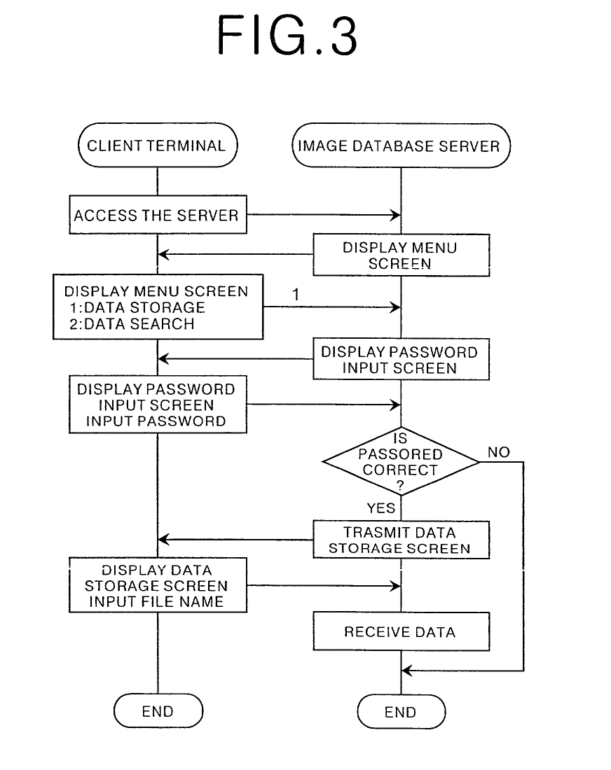

Operation of the centralized medical image management system in this embodiment having the above configuration will be explained next. FIG. 3 is a flow chart showing data storage processing in the centralized medical image management system in this embodiment.

In order to receive a service from the centralized medical image management system, any one of the client terminals 12 in the medical facility 10 connects itself to the Internet by using the modem 13 thereof via the telephone line 40 so that data transmission and data reception can be carried out therebetween.

The image data sets representing the medical images photographed in the medical facilities 10 and the accompanying information thereof are stored in the hard discs of the client terminals 12 in the medical facilities 10. When an operator in the medical facility 10 accesses a Web site set by the provider 30 managing the image database server 32 by using any one of the client terminals 12 therein, a menu screen is transmitted from the image database server 32 to the client terminal 12 and displayed on the client terminal. Items such as data storage, data search, and application or inquiry to the medical image management system are included in the menu.

When the operator stores any one of the image data sets in the image database server 32, the operator selects a number corresponding to “data storage”, and inputs the number from the client terminal 12. When a signal of data storage processing selection is input from the client terminal 12 to the image database server 32, the image database server 32 transmits a password input screen to the client terminal 12 and displays the screen on the terminal 12. The operator inputs the password at a predetermined position of the password input screen, and transmits the password to the image database server 32. When permission of the image-data storage processing is confirmed based on the password, a data storage screen is transmitted from the image database server 32 to the client terminal 12, and displayed on the terminal.

The operator inputs a file name and the like of the image data set to be stored, at a predetermined position of the data storage screen. A file having the image data set and the accompanying information thereof is then transmitted to the image database server 32. The image database server 32 receives the file of the image data and the accompanying information, and stores the file in the data storage unit 32a thereof.

When the image data set and the accompanying information are sent for storage, the file thereof may be sent as it is, as has been described above. Alternatively, the data storage screen may have input areas for items of the accompanying information so that the accompanying information can be sent directly from the input device of the client terminal 12 to the image database server 32 without using a file. In this case, a chart or a relevant report or the like regarding a patient corresponding to the image data set can also be input in addition to the accompanying information. The content of the chart and the report may be input to input areas therefor set in the screen or transmitted as image data by using a scanner or the like.

When the image data set and the accompanying information are stored in the data storage unit 32a, the image data and the accompanying information may be managed as one file, or managed separately from each other by using a common management number or the like assigned thereto. In this case, the data storage unit 32a may be divided physically.

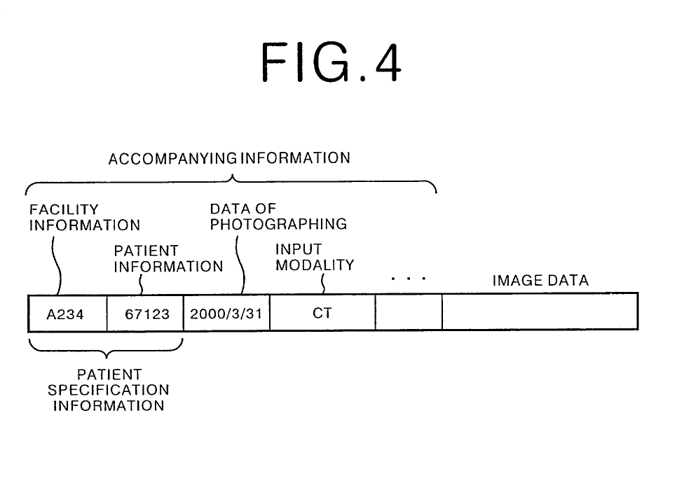

The patient specification information as a portion of the accompanying information may be issued by the provider according to a rule applied to all the medical facilities 10 at the time of data storage processing. In this manner, each of the medical facilities 10 does not need to individually manage the patient specification information comprising a character string and the like, and the patient specification information used for one of the medical facilities 10 is not used for another one of the medical facilities 10. Moreover, since the patient specification information is determined for each patient, an image of a patient can be exchanged between the medical facilities in the case where the image photographed in the past at another one of the medical facilities 10 is necessary or in the case where the patient needs to be transferred. If the patient specification information comprises data combining patient information assigned to a patient by one of the medical facilities and the facility information specified by the provider as shown in FIG. 4, each of the medical facilities 10 can use any numbers or the like such as a consultation ticket number as the patient information. In this manner, the medical facilities can easily manage the patient specification information.

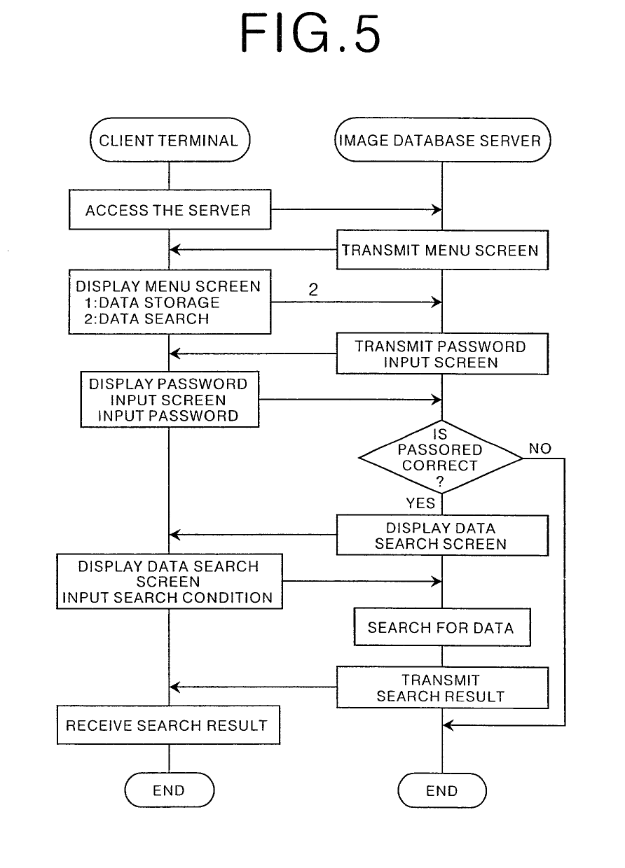

A flow of data search processing in the centralized medical image management system in this embodiment will be explained next with reference to FIG. 5. When an operator in the medical facility 10 searches for one of the image data sets stored in the image database server 32, a number corresponding to “data search” in the menu screen transmitted from the image database server 32 to the client terminal 12 of the operator is selected and input from the client terminal 12.

After a signal of data search processing selection is transmitted from the client terminal 12 to the image database server 32, the image database server 32 transmits the password input screen to the client terminal 12 and displays the screen on the terminal 12. The operator in the medical facility 10 inputs the password at the predetermined position in the screen and transmits the password to the image database server 32. When permission of the image data search processing is confirmed based on the password, the data search screen is transmitted from the image database server 32 to the client terminal 12 and displayed on the terminal 12.

The operator in the medical facility 10 inputs the search condition for the image data set to be searched for at a predetermined position on the data search screen. The search condition can be the information stored as the accompanying information, namely the patient information such as the name and a consultation ticket number of the patient, the date of photographing, the photographing menu, the input modality, and the facility information. In the case where the chart and the report regarding the image data set are stored, the image data set can be searched for by using a management number or the like of the chart and the report.

When the image database server 32 receives the search condition from the client terminal 12, the program stored in the program storage unit 32b of the image database server 32 searches the data storage unit 32a in the image database server, and a search result is transmitted from the image database server 32 to the client terminal 12 to be received by the terminal.

Regarding the data search, it is preferable for not only the medical facility that has stored the image data set in the image database server but also a plurality of pertinent facilities including doctors and the patient himself/herself to be able to carry out the search. In this case, the search is preferably carried out after a password and patient specification information have been acquired.

The password described above can be an account password used to pay a predetermined charge for storage and search of the image data.

In order to prevent leakage of the information regarding patients, it is preferable for at least the patient specification information to be encrypted at the medical facilities 10. In other words, the information by which patients can be identified is managed and encrypted by the medical facilities 10 so that the names of the patients cannot be recognized at the time of transmission, reception, and storage.

The timing of checking the password can be changed depending on a permission status of respective services, and only the data search processing can be allowed depending on the timing, for example.

In the centralized medical image management system described above, not only the medical image data sets and the accompanying information but also charts, reports and the like not related to the image data can also be stored.

What is claimed is:

1. A centralized medical image management system comprising:
client terminals installed in medical facilities and an image database server, the client terminals enabling transmission and reception of sets of medical image data together with accompanying information regarding the sets of medical image data via a public communications network; and
the image database server having functions of receiving the sets of medical image data and the accompanying information transmitted from the client terminals via the public communications network, storing the sets of medical image data and the accompanying information that have been received, searching for a desired one of the sets of medical image data stored therein by using the accompanying information, and transmitting the set of medical image data, wherein,
by an input of a desired search condition using a portion of the accompanying information from any one of the client terminals to the image database server, the image database server searches for the set of medical image data corresponding to the search condition and transmits the set of medical image data to the client terminal.

2. A centralized medical image management system as defined in claim 1, the image database server comparing a password input from any one of the client terminals with a password stored in advance, searching for the set of medical image data corresponding to the accompanying information input as the search condition from the client terminal if the passwords match up, and transmitting the set of medical image data to the client terminal.

3. A centralized medical image management system as defined in claim 1 or 2, wherein the accompanying information includes at least one of items comprising patient specification information, the date of photographing, a photographing menu, an input modality, and facility information.

4. A centralized medical image management system as defined in claim 1, wherein the accompanying information includes a combination of facility information and patient specification information.

5. A centralized medical image management system as defined in claim 2, wherein the accompanying information includes a combination of facility information and patient specification information.

6. A centralized medical image management system as defined in claim 3, wherein the accompanying information includes a combination of the facility information and the patient specification information.

7. A centralized medical image management system as defined in claim 1, wherein the accompanying information includes patient specification information encrypted by the medical facilities.

8. A centralized medical image management system as defined in claim 2, wherein the accompanying information includes patient specification information encrypted by the medical facilities.

9. A centralized medical image management system as defined in claim 3, wherein the patient specification information is encrypted by the medical facilities.

10. A centralized medical image management system as defined in claim 4, wherein the patient specification information is encrypted by the medical facilities.

11. The image database server used in the centralized medical image management system defined in claim 1, the image database server having the functions of receiving the sets of medical image data together with the accompanying information transmitted from the client terminals via the public communications network, storing the sets of medical image data and the accompanying information, searching for the desired one of the sets of medical image data stored therein by using the accompanying information, and transmitting the set of medical image data.

12. The image database server as defined in claim 11, further having functions of receiving a password, comparing the password with a password stored therein in advance, and searching for the desired one of the sets of medical image data stored therein by using the accompanying information if the passwords match up.

13. The client terminal used in the centralized medical image management system defined in claim 1, the client terminal comprising:
data transmission means for transmitting the sets of the medical image data and the accompanying information regarding the sets of medical image data to the image database server via the public communications network;
search condition transmission means for transmitting the search condition using the accompanying information used for searching for the desired one of the sets of the medical image data stored in the image database server; and
image data reception means for receiving the set of the medical image data corresponding to the search condition.

14. The client terminal as defined in claim 13, further comprising password transmission means for transmitting a password to the image database server.

15. A computer-readable recording medium storing a program to cause a computer to execute the procedures of:
transmitting sets of medical image data together with accompanying information regarding the sets of the medical image data to an image database server via a public communications network;
transmitting a search condition using the accompanying information used for searching for a desired one of the sets of the medical image data stored in the image database server; and
receiving the set of the medical image data corresponding to the search condition.

16. A centralized medical image management method comprising the steps of:
installing, in medical facilities, client terminals enabling transmission and reception of sets of medical image data together with accompanying information regarding the sets of the medical image data via a public communications network;
transmitting the sets of medical image data and the accompanying information via the public communications network from the client terminals to an image database server installed separately from the medical facilities;
storing the sets of medical image data and the accompanying information in the image database server;
inputting a desired search condition using a portion of the accompanying information from any one of the client terminals to the image database server; and
searching the image database server for a desired one of the sets of medical image data corresponding to the accompanying information based on the search condition, and transmitting the set of medical image data from the image database server to the client terminal.
